(19) United States
(12) Patent Application Publication
(10) Pub. No.: US 2026/0019756 A1
(43) Pub. Date: Jan. 15, 2026

(54) HEARING DEVICES, SYSTEMS, AND METHODS FOR USERS WITH UNILATERAL HEARING

(71) Applicant: GN Hearing A/S, Ballerup (DK)

(72) Inventors: Ronald Petrus Nicolaas DUISTERS, EINDHOVEN (NL); Job GEURTS, Eindhoven (NL); Manman GU, Long Grove, IL (US); Magali Aline Jeannine Raymonde MONOD-COTTE, Eindhoven (NL); Niels ODDERSHEDE, Frederikssund (DK); Casper Krüger TROELSEN, Ballerup (DK); Anja ŽILJAK, Eindhoven (NL)

(73) Assignee: GN Hearing A/S, Ballerup (DK)

(21) Appl. No.: 18/773,304

(22) Filed: Jul. 15, 2024

(51) Int. Cl. H04R 25/00; H01Q 1/27

(52) U.S. Cl. CPC H04R 25/43; H01Q 1/273; H04R 25/554; H04R 25/558; H04R 25/604; H04R 2225/51; H04R 2225/53; H04R 2225/55

(57) ABSTRACT

A hearing system includes: a first hearing device; and a second hearing device; wherein the first hearing device comprises a first microphone system configured to provide a first microphone signal, a first processing unit, a first communication unit, and a first antenna; wherein the second hearing device comprises a second processing unit, a second communication unit, a second antenna, and a receiver configured to provide an audio output; wherein the first hearing device has first and second operation modes; wherein the first hearing device is configured to transmit the first microphone signal or audio signal based on the first microphone signal to the second hearing device via a wireless communication link when the first hearing device is in the first operation mode; and wherein when the first hearing device is in the second operation mode, the wireless communication link is disabled.

### FIELD

The present disclosure relates to hearing devices, hearing systems, and method performed by hearing devices and hearing systems. In particular, the present disclosure relates to hearing systems having first and second hearing devices for users with unilateral hearing, such as single sided deafness.

### BACKGROUND

Hearing devices are configured to provide sound for users. For example, hearing aids, headsets, earbuds, etc., all have receivers configured to generate sound for users. Hearing devices for users with unilateral hearing generally have limited capabilities and functionalities. Also, hearing devices for users with unilateral hearing generally consume much battery power because the hearing device at the deaf side of the user is generally required to constantly transmit audio signals to the contralateral hearing device.

New hearing devices and methods performed by such hearing devices are disclosed herein.

### SUMMARY

A hearing system includes: a first hearing device configured for wear at a first ear of a user; and a second hearing device configured for wear at a second ear of the user; wherein the first hearing device comprises a first microphone system configured to provide a first microphone signal, a first processing unit, a first communication unit, and a first antenna coupled to the first communication unit; wherein the second hearing device comprises a second microphone system configured to provide a second microphone signal, a second processing unit, a second communication unit, a second antenna coupled to the second communication unit, and a receiver configured to provide an audio output; wherein the first hearing device has a first operation mode, and a second operation mode; wherein the first hearing device is configured to transmit the first microphone signal or audio signal based on the first microphone signal to the second hearing device via a wireless communication link between the first antenna of the first hearing device and the second antenna of the second hearing device when the first hearing device is in the first operation mode; and wherein when the first hearing device is in the second operation mode, the wireless communication link is disabled.

Optionally, when the first hearing device is in the second operation mode, the first hearing device remains on while the wireless communication link is disabled.

Optionally, the hearing system has a first system mode, and wherein when the hearing system is in the first system mode, the audio output from the receiver of the second hearing device is based on the second microphone signal and not based on the first microphone signal.

Optionally, the first system mode is defined by the first hearing device being in the second operation mode, and by the second hearing device being in an unmute mode.

Optionally, when the hearing system is in the first system mode, the first communication unit and/or the first antenna of the first hearing device is disabled to disable the wireless communication link.

Optionally, the second hearing device comprises a mixer, and wherein the mixer of the second hearing device is configured to provide an output that is based on the second microphone signal, not based on the first microphone signal, when the hearing system is in the first system mode.

Optionally, the hearing system has a second system mode, and wherein when the hearing system is in the second system mode, the audio output from the receiver of the second hearing device is based on the first microphone signal transmitted from the first hearing device to the second hearing device, and also based on the second microphone signal from the second microphone of the second hearing device.

Optionally, the second system mode is defined by the first hearing device being in the first operation mode, and by the second hearing device being in an unmute mode.

Optionally, when the hearing system is in the second system mode, the first communication unit and/or the first antenna of the first hearing device is not disabled to maintain the wireless communication link.

Optionally, the second hearing device comprises a mixer, and wherein the mixer of the second hearing device is configured to provide an output that is based on the second microphone signal and the first microphone signal, when the hearing system is in the second system mode.

Optionally, the hearing system has a third system mode, and wherein when the hearing system is in the third system mode, the audio output from the receiver of the second hearing device is based on the first microphone signal and not based on the second microphone signal.

Optionally, the third system mode is defined by the first hearing device being in the first operation mode, and by the second hearing device being in a mute mode.

Optionally, when the hearing system is in the third system mode, the first communication unit and/or the first antenna of the first hearing device is not disabled to maintain the wireless communication link.

Optionally, the second hearing device comprises a mixer, and wherein the mixer of the second hearing device is configured to provide an output that is based on the first microphone signal, not based on the second microphone signal, when the hearing system is in the third system mode.

Optionally, the hearing system has a fourth system mode, and wherein when the hearing system is in the fourth system mode, the audio output from the receiver of the second hearing device is independent of the first microphone signal from the first microphone of the first hearing device, and is independent of the second microphone signal from the second microphone of the second hearing device.

Optionally, the fourth system mode is defined by the hearing device being in the second operation mode, and by the second hearing device being in a mute mode.

Optionally, when the hearing system is in the fourth system mode, the first communication unit and/or the first antenna of the first hearing device is disabled to disable the wireless communication link.

Optionally, the second hearing device comprises a mixer, and wherein the mixer of the second hearing device is configured to provide an output that is not based on the second microphone signal, and is not based on the first microphone signal, when the hearing system is in the fourth system mode.

Optionally, the hearing system further includes a user-control configured to allow the user to mute the first hearing device, to mute the second hearing device, or to mute both the first hearing device and the second hearing device.

Optionally, the user-control comprises a first control at the first hearing device and a second control at the second hearing device.

Optionally, the user-control is at a handheld device that is configured to wirelessly communicate with the first hearing device and/or the second hearing device.

Optionally, the first hearing device is configured to disable the wireless communication link.

Optionally, the first hearing device is configured to communicate with the second hearing device to inform the second hearing device before disabling the wireless communication link.

Optionally, the second hearing device comprises a mixer.

Optionally, the mixer of the second hearing device is configured to provide a mixer output that is based on (1) the first microphone signal or the audio signal from the first hearing device, and (2) the second microphone signal from the first hearing device, when the first hearing device is in the first operation mode, and when the second hearing device is in an unmute mode.

Optionally, the mixer of the second hearing device is configured to provide a mixer output that is based on only the second microphone signal from the second microphone of the second hearing device, when the first hearing device is in the second operation mode, and when the second hearing device is in an unmute mode.

Optionally, the mixer of the second hearing device is configured to provide a mixer output that is based on only the first microphone signal from the first microphone of the first hearing device or only the audio signal, when the first hearing device is in the first operation mode, and when the second hearing device is in a mute mode.

Optionally, the mixer of the second hearing device is configured to provide no output, a null output, a media output, or an output that is independent of the first microphone signal and the second microphone signal, when the first hearing device is in the second operation mode, and when the second hearing device is in a mute mode.

Optionally, when the first hearing device is in the second operation mode, the first communication unit and/or the first antenna is disabled by reducing or removing power supplied to the first communication unit and/or to the first antenna.

Optionally, when the first hearing device is in the second operation mode, the first communication unit and/or the first antenna is disabled by an operation of a switch inside the hearing device.

Optionally, when the first hearing device is in the second operation mode, the second communication unit of the second hearing device is in a standby mode.

Optionally, the first operation mode of the first hearing device is an unmute mode, and the second operation mode of the first hearing device is a mute mode.

Optionally, the first antenna of the first hearing device comprises a magnetic induction antenna.

Optionally, the magnetic induction antenna is configured to transmit the first microphone signal or the audio signal as audio data.

Optionally, the first hearing device further comprises an additional first antenna configured to communicate with an exterior device.

Optionally, the exterior device comprises a remote control, a phone, or a watch, a tablet, a computer, or a communication device.

Optionally, the additional first antenna of the first hearing device is configured to provide communication at 2.4 GHz.

Optionally, the additional first antenna of the first hearing device is configured to communicate non-audio data with the second hearing device.

Optionally, the non-audio data comprises control data.

Optionally, the second hearing device comprises an additional second antenna configured to communicate with the additional first antenna of the first hearing device.

A hearing device configured for wear at a first ear of a user, wherein the hearing device is configured to communicate with another hearing device that is configured for wear at a second ear of the user, the hearing device includes: a first microphone system configured to provide a first microphone signal; a first processing unit; a first communication unit; and a first antenna coupled to the first communication unit; wherein the hearing device has a first operation mode, and a second operation mode; wherein the hearing device is configured to transmit the first microphone signal or audio signal based on the first microphone signal to the other hearing device via a wireless communication link between the hearing device and the other hearing device when the hearing device is in the first operation mode; and wherein when the hearing device is in the second operation mode, the wireless communication link is disabled.

Optionally, when the hearing device is in the second operation mode, the hearing device remains on while the wireless communication link is disabled.

Optionally, the hearing device further includes a user-control configured to allow the user to mute the hearing device.

Optionally, the user-control is at a handheld device that is configured to wirelessly communicate with the hearing device.

Optionally, the hearing device is configured to disable the wireless communication link.

Optionally, the hearing device is configured to communicate with the other hearing device to inform the other hearing device before disabling the wireless communication link.

Optionally, when the hearing device is in the second operation mode, the first communication unit and/or the first antenna is disabled by reducing or removing power supplied to the first communication unit and/or to the first antenna.

Optionally, when the hearing device is in the second operation mode, the first communication unit and/or the first antenna is disabled by an operation of a switch inside the hearing device.

Optionally, when the hearing device is in the second operation mode, the second communication unit of the other hearing device is in a standby mode.

Optionally, the first operation mode of the hearing device is an unmute mode, and the second operation mode of the hearing device is a mute mode.

Optionally, the first antenna of the hearing device comprises a magnetic induction antenna.

Optionally, the magnetic induction antenna is configured to transmit the first microphone signal or the audio signal as audio data.

Optionally, the hearing device further includes an additional first antenna configured to communicate with an exterior device.

Optionally, the exterior device comprises a remote control, a phone, or a watch, a tablet, a computer, or a communication device.

Optionally, the additional first antenna of the hearing device is configured to provide communication at 2.4 GHz.

Optionally, the additional first antenna of the hearing device is configured to communicate non-audio data with the other hearing device.

Optionally, the non-audio data comprises control data.

Optionally, the hearing device further comprises an additional antenna for communicating control data with the other hearing device.

A hearing device configured to communicate with another hearing device, the other hearing device configured for wear at a first ear of a user, the hearing device configured for wear at a second ear of the user, the hearing device includes: a microphone system configured to provide a microphone signal; a processing unit comprising a mixer; and a communication unit; an antenna coupled to the communication unit; wherein the processing unit is configured to determine if a wireless communication link between the hearing device and the other hearing device is disabled or not, determine whether the hearing device is in a first operation mode or a second operation mode, and control the mixer to provide: (1) a first mixer output that is based on the microphone signal, and not based on any microphone signal from the other hearing device, if the processing unit determines that the hearing device is in the first operation mode, and that the wireless communication link is disabled, (2) a second mixer output that is based on the microphone signal, and also based on a microphone signal from the other hearing device, if the processing unit determines that the hearing device is in the first operation mode, and that the wireless communication link is not disabled, (3) a third mixer output that is based on a microphone signal from the other hearing device, and not based on the microphone signal from the hearing device, if the processing unit determines that the hearing device is in the second operation mode, and that the wireless communication link is not disabled, or (4) no output, or a fourth mixer output that is a null output, a media output, or an output independent of the microphone signal and a microphone signal from the other hearing device, if the processing unit determines that the hearing device is in the second operation mode, and that the wireless communication link is disabled.

Optionally, the hearing device further includes a user-control configured to allow the user to mute the hearing device, to mute the other hearing device, or to mute both the hearing device and the other hearing device.

Optionally, the hearing device is configured to communicate with a handheld device having a user-control configured to allow the user to mute the hearing device, to mute the other hearing device, or to mute both the hearing device and the other hearing device.

Optionally, the hearing device is in the second operation mode when the hearing device is muted, and is in the first operation mode when the hearing device is unmuted.

Optionally, the hearing device is configured to receive a notification from the other hearing device before the other hearing device disales the wireless communication link.

Optionally, when wireless communication link is disabled, the communication unit of the hearing device is in a standby mode.

Optionally, the other hearing device is an unmute mode when the wireless communication link is not disabled, and is in a mute mode when the wireless communication link is disabled.

Optionally, the antenna of the hearing device comprises a magnetic induction antenna.

Optionally, the magnetic induction antenna is configured to receive an audio signal from the other hearing device, the audio signal being a microphone signal of the other hearing device, or based on a microphone signal of the other hearing device.

Optionally, the hearing device further includes an additional first antenna configured to communicate with an exterior device.

Optionally, the exterior device comprises a remote control, a phone, or a watch, a tablet, a computer, or a communication device.

Optionally, the additional first antenna of the hearing device is configured to provide communication at 2.4 GHz.

Optionally, the additional antenna of the hearing device is configured to communicate non-audio data with the other hearing device.

Optionally, the non-audio data comprises control data.

Optionally, the hearing device further includes an additional antenna configured to communicate control data with the other hearing device.

A hearing system includes: a first hearing device configured for wear at a first ear of a user; and a second hearing device configured for wear at a second ear of the user; wherein the first hearing device comprises a first microphone system configured to provide a first microphone signal, a first processing unit, a first communication unit, and a first antenna coupled to the first communication unit; wherein the second hearing device comprises a second processing unit, a second communication unit, a second antenna coupled to the second communication unit, and a receiver configured to provide an audio output; wherein the first hearing device has a first operation mode, and a second operation mode; wherein the first hearing device is configured to transmit the first microphone signal or audio signal based on the first microphone signal to the second hearing device via a wireless communication link between the first antenna of the first hearing device and the second antenna of the second hearing device when the first hearing device is in the first operation mode; and wherein when the first hearing device is in the second operation mode, the wireless communication link is disabled.

A hearing device configured to communicate with another hearing device, the other hearing device configured for wear at a first ear of a user, the hearing device configured for wear at a second ear of the user, the hearing device includes: a processing unit; a communication unit; an antenna coupled to the communication unit; and a receiver; wherein the processing unit is configured to determine if a wireless communication link between the hearing device and the other hearing device is disabled or not, and to provide: (1) a first output that is not based on any microphone signal from the other hearing device, if the processing unit determines that the wireless communication link is disabled, or (2) a second output that is based on a microphone signal from the other hearing device, if the processing unit determines that the wireless communication link is not disabled; wherein the receiver is configured to provide an audio output based on the first output or the second output.

Optionally, the hearing device further includes a microphone system that has been disabled.

Optionally, the hearing device further includes a user-control configured to allow the user to mute the other hearing device.

Optionally, the hearing device is configured to receive a notification from the other hearing device before the other hearing device disales the wireless communication link.

Optionally, when wireless communication link is disabled, the communication unit of the hearing device is in a standby mode.

Optionally, the antenna of the hearing device comprises a magnetic induction antenna.

Optionally, the magnetic induction antenna is configured to receive an audio signal from the other hearing device, the audio signal being a microphone signal of the other hearing device, or based on a microphone signal of the other hearing device.

Optionally, the hearing device further includes an additional first antenna configured to communicate with an exterior device.

Optionally, the exterior device comprises a remote control, a phone, or a watch, a tablet, a computer, or a communication device.

Optionally, the additional first antenna of the hearing device is configured to provide communication at 2.4 GHz.

Optionally, the additional antenna of the hearing device is configured to communicate non-audio data with the other hearing device.

Optionally, the non-audio data comprises control data.

Optionally, the hearing device further includes an additional antenna configured to communicate control data with the other hearing device.

Other features and advantageous will be described in the detail description.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 illustrates a hearing system having a first hearing device and a second hearing device in accordance with some embodiments.

FIG. 2 illustrates the hearing system of FIG. 1 being in a first system mode, with the first hearing device being in a mute mode, and the second hearing device being in an unmute mode.

FIG. 3 illustrates the hearing system of FIG. 1 being in a second system mode, with the first hearing device being in an unmute mode, and the second hearing device being in an unmute mode.

FIG. 4 illustrates the hearing system of FIG. 1 being in a third system mode, with the first hearing device being in an unmute mode, and the second hearing device being in a mute mode.

FIG. 5 illustrates the hearing system of FIG. 1 being in a fourth system mode, with the first hearing device being in a mute mode, and the second hearing device being in a mute mode.

FIG. 6 illustrates a method performed by the first hearing device of FIG. 1.

FIG. 7 illustrates a method performed by the second hearing device of FIG. 1.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

### Hearing System

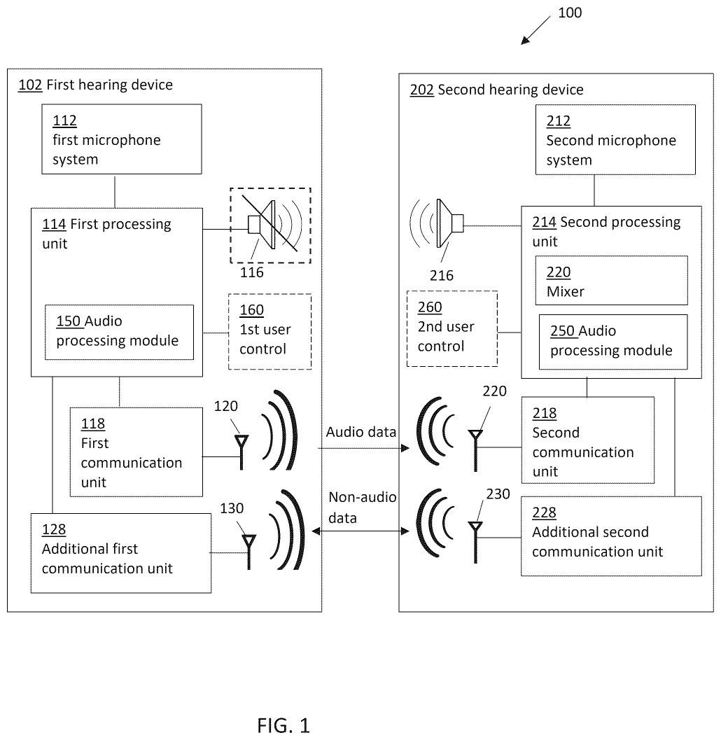

FIG. 1 illustrates a hearing system 100 in accordance with some embodiments. The hearing system 100 has a first hearing device 102 and a second hearing device 202.

The first hearing device 102 has a first microphone system 112, a first processing unit 114, a first communication unit 118 and a first antenna 120 coupled with the first communication unit 118. The first hearing device 102 also includes an additional first communication unit 128 and an additional first antenna 130 coupled with the additional first communication unit 128. The first hearing device 102 may further optionally include a receiver (e.g., speaker) 116 that is configured to be muted during operation. Alternatively, the receiver 116 is optional, and the first hearing device 102 may not include the receiver 116. The first hearing device 102 may also optionally include a first user control 160 configured to operate the first hearing device 102. In other cases, the first hearing device 102 may not include the first user control 160.

The second hearing device 202 includes a second microphone system 212, a second processing unit 214, a receiver (e.g., speaker) 216, a second communication unit 218, and a second antenna 220 coupled with the second communication unit 218. The second hearing device 202 also includes an additional second communication unit 228 and an additional second antenna 230 coupled with the additional second communication unit 228. The second hearing device 202 may further optionally include a second user control 260 configured to operate the second hearing device 202. In other cases, the second hearing device 202 may not include the second user control 260.

The first hearing device 102 and/or the second hearing device 202 may be embodied in various housing styles or form factors.

In some cases, the hearing device 102/202 may be a hearing aid. The hearing aid may have one of a variety of different form factors. Some of these form factors are Behind-the-Ear (BTE) hearing device, Receiver-in-Canal (RIC) hearing device, Receiver-in-Ear (RIE) hearing device or Microphone-and-Receiver-in-Ear (MaRIE) hearing device. These devices may comprise a BTE unit configured to be worn behind the ear of the user and an in the ear (ITE) unit configured to be inserted partly or fully into the user's ear canal. Generally, the BTE unit may comprise at least one input transducer, a power source and a processing unit. The term BTE hearing device refers to a hearing device where the receiver, i.e. the output transducer, is comprised in the BTE unit and sound is guided to the ITE unit via a sound tube connecting the BTE and ITE units, whereas the terms RIE, RIC and MaRIE hearing devices refer to hearing devices where the receiver may be comprised in the ITE unit, which is coupled to the BTE unit via a connector cable or wire configured for transferring electric signals between the BTE and ITE units.

In some cases, the hearing device 102/202 may be an In-the-Ear (ITE) hearing device, a Completely-in-Canal (CIC) hearing device, or an Invisible-in-Canal (IIC) hearing device. Any of these hearing devices may comprise an ITE unit, wherein the ITE unit may comprise at least one input transducer, a power source, a processing unit and an output transducer. Also, in some cases, the hearing device 102/202 may be a custom device, meaning that the ITE unit may comprise a housing having a shell made from a hard material, such as a hard polymer or metal, or a soft material such as a rubber-like polymer, molded to have an outer shape conforming to the shape of the specific user's ear canal. In other cases, the hearing device 102/202 may be a non-customized device.

In other cases, each of the hearing devices 102, 202 may be an earbud.

In further cases, the hearing devices 102, 202 may be parts of a headset. The headset may have one or more on-the-ear headphone(s), or one or more over-the-ear headphone(s).

In still further cases, the hearing devices 102, 202 may be parts of an ear protection device.

The first hearing device 102 may be selectively placed in an unmute mode (first operation mode) or a mute mode (second operation mode) in response to a user input from the user of the hearing system 100. The second hearing device 202 may also be selectively placed in an unmute mode (first operation mode) or a mute mode (second operation mode) in response to a user input from the user of the hearing system 100. In some cases, if the first hearing device 102 includes the first user control 160, the first hearing device 102 may be selectively placed in the unmute mode or the mute mode by the user operating the first user control 160. In other cases, the second user control 260 at the second hearing device 202 may be operated by the user to selectively place the first hearing device 102 in the unmute mode or the mute mode. In such cases, after the user operates the second user control 260, the second hearing device 202 then transmits a control signal via the additional second antenna 230 to the first hearing device 102. The first hearing device 102 then enters into the unmute mode or the mute mode based on the control signal. In further cases, the user may utilize an exterior device (e.g., accessory device) to control the first hearing device 102 and/or the second hearing device 202. By means of non-limiting examples, the exterior/accessory device may be a remote control, a phone, or a watch, a tablet, a computer, or a communication device.

In the illustrated embodiments, when the first hearing device 102 is in the unmute mode, the first antenna 120 and the first communication unit 118 is not disabled to maintain a wireless communication link between the first hearing device 102 and the second hearing device 202, and transmits first microphone signal (e.g., generated by the first microphone system 112, or derived based on output of the first microphone system 112) to the second hearing device 202 via the first antenna 120.

When the first hearing device 102 is in the mute mode, the first antenna 120 and/or the first communication unit 118 is disabled to disable the wireless communication link between the first hearing device 102 and the second hearing device 202. Because the wireless communication link is disabled in the mute mode of the first hearing device 102, the first hearing device 102 does not transmit any microphone signal to the second hearing device 202 when the first hearing device 102 is in the mute mode. Disabling the wireless communication link by disabling the first antenna 120 and/or the first communication unit 118 of the first hearing device 102 is advantageous. This is because when the user does not want to hear sound from the side of the user where the first hearing device 102 is worn, then there is no need to transmit audio signal (representing captured sound) from the first hearing device 102 to the second hearing device 202. Accordingly, disabling the first antenna 120 and/or the first communication unit 118 will stop the transmission of audio signal from the first hearing device 102 to the second hearing device 202, and also reduce power consumption (that may otherwise be wasted to keep the wireless communication link active).

When the second hearing device 202 is in the unmute mode, the receiver 216 provides audio output based on second microphone signal provisioned by the second hearing device 202. The second microphone signal may be generated by the second microphone system 212 of the second hearing device 202, or may be derived from output provided by the second microphone system 212.

When the second hearing device 202 is in the mute mode, the receiver 216 does not provide audio output that is based on the second microphone signal provisioned by the second hearing device 202.

As discussed, when the first hearing device 102 is in the mute mode, the wireless communication link between the first hearing device 102 and the second hearing deice 202 is disabled. Various techniques may be employed to disable the wireless communication link between the first hearing device 102 and the second hearing device 202. In some cases, when the first hearing device 102 is in the mute mode, the first communication unit 118 and/or the first antenna 120 is disabled by reducing or removing power supplied to the first communication unit 118 and/or to the first antenna 120. Alternatively or additionally, when the first 102 hearing device is in the mute mode, the first communication unit 118 and/or the first antenna 120 may be disabled by an operation of a switch inside the first hearing device 102. For example, the switch may disconnect a power supply link to the first communication unit 118 and/or the first antenna 120. The switch may be implemented using a physical switch and/or a software switch.

In some cases, before the first hearing device 102 disables the wireless communication link, the first hearing device 102 may transmit a notification informing the second hearing device 202 that the wireless communication link will be disabled. In such cases, upon receiving the notification, the second hearing device 202 may temporarily mute the receiver 216 while the wireless communication link is being disabled. After the wireless communication link has been disabled, the second hearing device 202 may then unmute the receiver 216. This feature is advantageous because sometimes a termination of a wireless communication link may cause an undesirable audio artifect to be heard through the receiver 216. In other cases, the above feature is optional, and the first hearing device 102 may not transmit a notification (regarding an impending disabling of the wireless communication link) to the second hearing device 202.

Also, in some cases, when the first hearing device 102 is in the mute mode, the second hearing device 202 may be in a standby mode, in which mode, the power supply for the second communication unit 218 and/or the antenna 220 in the second hearing device 202 may be reduced or terminated. Such feature also provide some power saving for the second hearing device 202. In other cases, when the first hearing device 102 is in the mute mode, the second hearing device 202 may not be in any standby mode.

As shown in FIG. 1, the the second hearing device 202 includes a mixer 220 configured to provide a mixer output for the second receiver 216. The second receiver 216 is configured to generate sound for perception by the user based on the mixer output from the mixer 220. In the illustrated embodiments, the second processing unit 214 of the second hearing device 202 is configured to determine if a wireless communication link between the first hearing device 102 and the second hearing device 202 is disabled or not, determine whether the second hearing device 202 is in a first operation mode (e.g., unmute mode) or a second operation mode (e.g., mute mode), and control the mixer 220 to provide: (1) a first mixer output that is based on the microphone signal from the second microphone system 212 of the second hearing device 202, and not based on any microphone signal from the first hearing device 102, if the processing unit 214 determines that the second hearing device 202 is in the first operation mode (e.g., unmute mode), and that the wireless communication link is disabled, (2) a second mixer output that is based on the microphone signal from the second microphone system 212 of the second hearing device 202, and also based on a microphone signal from the first hearing device 102, if the processing unit 214 determines that the second hearing device 202 is in the first operation mode (e.g., unmute mode), and that the wireless communication link is not disabled, (3) a third mixer output that is based on a microphone signal from the first hearing device 102, and not based on the microphone signal from the second microphone system 212 of the second hearing device 202, if the processing unit 214 determines that the second hearing device 202 is in the second operation mode (e.g., mute mode), and that the wireless communication link is not disabled, or (4) no output, or a fourth mixer output that is a null output, a media output, or an output independent of the microphone signal from the second microphone system 212 of the second hearing device 202, and independent of a microphone signal from the first hearing device 102, if the processing unit 214 determines that the second hearing device 202 is in the second operation mode (e.g., mute mode), and that the wireless communication link is disabled.

It should be noted that the term “mixer”, as used in this specification, is not limited to any particular component that add or aggregate two or more audio data from two or more sources, and may refer to any component that is capable of receiving two or more audio data, and providing an output that is based on the two or more audio data, or based on one of the plurality of audio data. For example, the output (mixer output) may be an aggregation of two audio data, a beamformed data derived from two or more audio data, a neural network output that is based on one or more audio data, a subset of two or more audio data, etc. By means of non-limiting examples, the mixer 220 may be an adder, a combiner, a beamformer (e.g., configured to perform bilateral beamforming using signal from the first hearing device 102), a neural network, a signal processor, a filter, etc.

In some embodiments, the second processing unit 214 of the second hearing device 202 may be configured to keep track of the operation mode the first hearing device 102 is in, and also to keep track of the operation mode the second hearing device 202 is in. Based on the tracked operation modes the hearing devices 102, 202 are in, the second processing unit 214 of the second hearing device 202 then control the mixer 220 to provide the desired mixer output or to provide no output.

The combination of an operation mode (e.g., mute mode or umute mode) of the first hearing device 102 and an operation mode (e.g., mute mode or unmute mode) of the second hearing device 202 provides or defines a system mode for the hearing system 100. In the illustrated embodiments, because each of the first and second hearing devices 102, 202 has at least two operation modes (e.g., mute mode and unmute mode), there are at least four system modes for the hearing system 100 defined by and/or based on these operation modes of the first and second hearing devices 102, 202. In particular, the hearing system 100 is (1) in a first system mode when the first hearing device 102 is in the mute mode and when the second hearing device 202 is in the unmute mode, (2) in a second system mode when the first hearing device 102 is in the unmute mode and when the second hearing device 202 is in the unmute mode, (3) in a third system mode when the first hearing device 102 is in the unmute mode and when the second hearing device 202 is in the mute mode, and (4) in a fourth system mode when the first hearing device 102 is in the mute mode and when the second hearing device 202 is in the mute mode.

In some cases, the second processing unit 214 of the second hearing device 202 may be configured to determine the system mode based on a determination of whether the first hearing device 102 is in the mute mode or unmute mode, and a determination of whether the second hearing device 202 is in the mute mode or unmute mode. For example, when the first hearing device 102 is in the unmute mode, the second processing unit 214 may determine that a first operation mode indicator M1 for the first hearing device 102 is 0. When the first hearing device 102 is in the mute mode, the second processing unit 214 may determine that the first operation mode indicator M1 for the first hearing device 102 is 1. Similarly, when the second hearing device 202 is in the unmute mode, the second processing unit 214 may determine that a second operation mode indicator M2 for the second hearing device 202 is 0. When the second hearing device 202 is in the mute mode, the second processing unit 214 may determine that the second operation mode indicator M2 for the second hearing device 202 is 1. The second processing unit 214 may determine a system mode for the hearing system based on the logical mapping:
(M1, M2)=(1, 0), then system mode=SM1
(M1, M2)=(0, 0), then system mode=SM2
(M1, M2)=(0, 1), then system mode=SM3
(M1, M2)=(1, 1), then system mode=SM4

In the illustrated example, if the system mode is SM1, then the mixer 220 of the second hearing device 202 provides a mixer output that is based on microphone signal form the second microphone system 212 of the second hearing device 202, and not based on any microphone signal from the first microphone system 112 of the first hearing device 102 (because the first hearing device 102 is muted as indicated by M1=1, and the second hearing device 202 is unmuted as indicated by M2=0). This system operation mode may be desirable when the user wants to hear sound captured by the second hearing device 202, and not sound captured by the first hearing device 102.

If the system mode is SM2, then the mixer 220 of the second hearing device 202 provides a mixer output that is based on both microphone signal from the first microphone system 112 of the first hearing device 102, and microphone signal from the second microphone system 212 of the second hearing device 202 (because the first hearing device 102 is unmuted as indicated by M1=0, and the second hearing device 202 is unmuted as indicated by M2=0). This system operation mode may be desirable when the user wants to hear both sound captured by the second hearing device 202, and sound captured by the first hearing device 102.

If the system mode is SM3, then the mixer 220 of the second hearing device 202 provides a mixer output that is based on microphone signal from the first microphone system 112 of the first hearing device 102, and not microphone signal from the second microphone system 212 of the second hearing device 202 (because the first hearing device 102 is unmuted as indicated by M1=0, and the second hearing device 202 is muted as indicated by M2=1). This system operation mode may be desirable when the user wants to hear sound captured by the first hearing device 102, and not sound captured by the second hearing device 202.

If the system mode is SM4, then the mixer 220 of the second hearing device 202 provides no output or a mixer output that a null output, a media output, or an output that is independent of microphone signal from the first microphone system 112 of the first hearing device 102, and independent of microphone signal from the second microphone system 212 of the second hearing device 202 (because the first hearing device 102 is muted as indicated by M1=1, and the second hearing device 202 is muted as indicated by M2=1). This system operation mode may be desirable when the user does not want to hear sound captured by the first hearing device 102, and does not want to hear sound captured by the second hearing device 202. For example, if the user wants to hear no noise from the environment, or wants to hear only media output (without any environmental noise), then the user may selects such system mode.

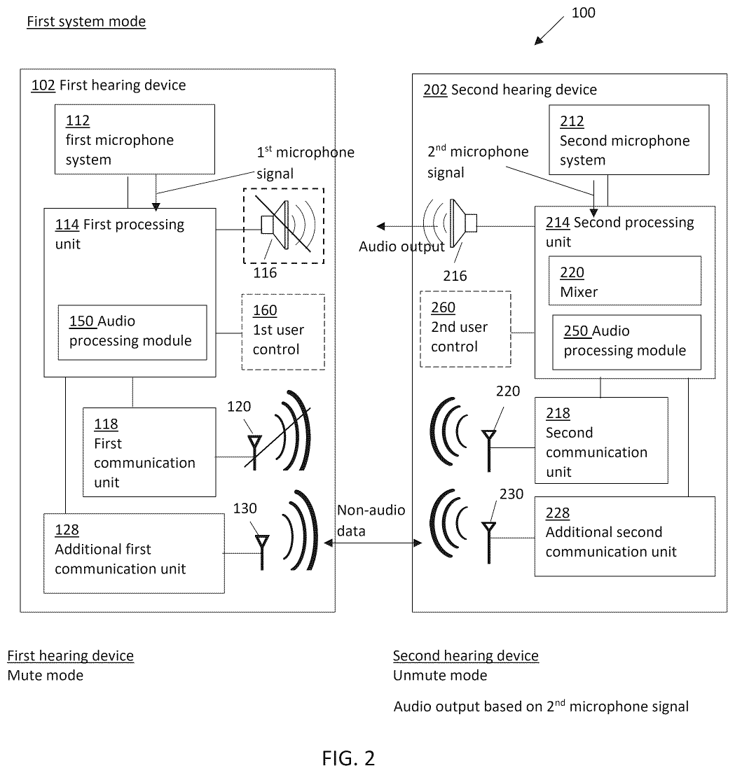

FIG. 2 illustrates the hearing system 100 of FIG. 1 being in a first system mode, with the first hearing device 102 being in a mute mode, and the second hearing device 202 being in an unmute mode. As shown in the figure, when the hearing system 100 is in the first system mode, the first hearing device 102 does not transmit microphone signal to the second hearing device 202 due to the wireless communication link between the first antenna 120 of the first hearing device 102 and the second antenna 220 of the second hearing device 202 being disabled. Also, when the hearing system 100 is in the first system mode, the receiver 216 of the second hearing device 202 provides audio output that is based on the second microphone signal. This allows the user to perceive sound captured by the second microphone system 212 of the second hearing device 202. However, the audio output provided by the receiver 216 of the second hearing device 202 is not based on any first microphone signal provisioned by the first hearing device 102 because there is no microphone signal transmitted wirelessly due to the disabled wireless communication link between the first antenna 120 of the first hearing device 102 and the second antenna 220 of the second hearing device 202. In the illustrated embodiments, the mixer 220 of the second hearing device 202 provides a mixer output that is based on microphone signal from the second microphone system 212 of the second hearing device 202, and not based on any microphone signal from the first microphone system 112 of the first hearing device 102. As a result, the user of the hearing system 100 receives audio output representing sound from the side (left side or right side) of the user wearing the second hearing device 202, and not sound from the other side of the user. This first system mode may be desirable in the situation in which the side of the user wearing the first hearing device 102 may have too much noise, or may have undesirable noise. In this situation, to prevent the unwanted noise from being combined with desirable sound at the side of the user wearing the second hearing device 202, the user may then operate the system 100 to enter into the first system mode.

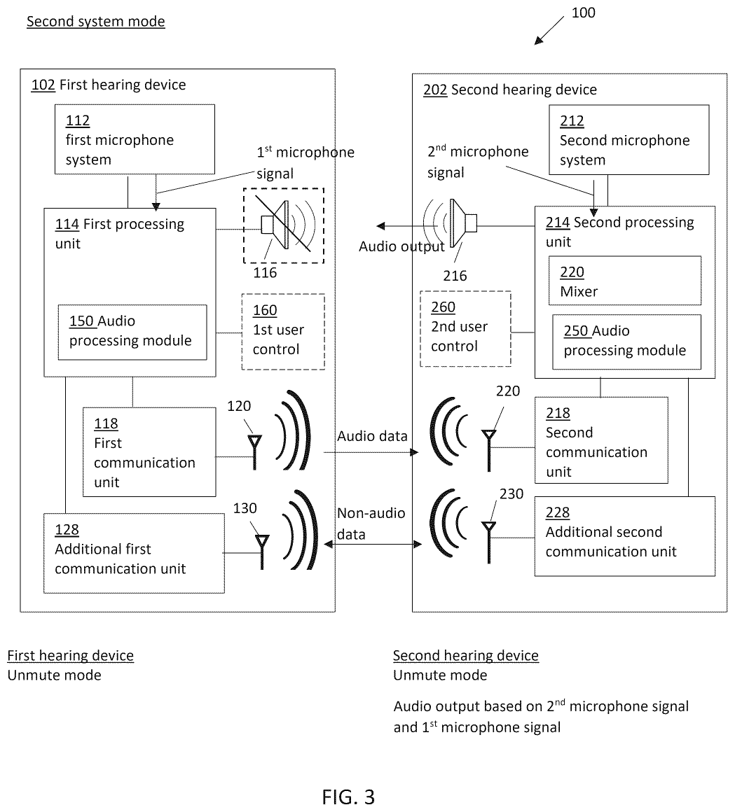

FIG. 3 illustrates the hearing system 100 of FIG. 1 being in a second system mode, with the first hearing device 102 being in an unmute mode, and the second hearing device 202 being in an unmute mode. This second system mode allows the “good” ear at one side (wearing the second hearing device 202) of the user to hear both (1) sound captured from the “good” ear side (the side wearing the second hearing device 202) of the user, and (2) sound captured from the other side of the user (the side wearing the first hearing device 102). As shown in the figure, when the hearing system 100 is in the second system mode, the first hearing device 102 transmits microphone signal to the second hearing device 202 due to the wireless communication link between the first antenna 120 of the first hearing device 102 and the second antenna 220 of the second hearing device 202 being maintained (not disabled). This allows the first microphone signal (representing sound captured from the side of the user wearing the first hearing device 102) provided by the first microphone 112 of the first hearing device 102 to be transmitted from the first hearing device 102 to the second hearing device 202 via the first antenna 120. Also, when the hearing system 100 is in the second system mode, the receiver 216 of the second hearing device 202 provides audio output that is based on the second microphone signal. This allows the user to perceive sound captured by the second microphone system 212 of the second hearing device 202. The audio output provided by the receiver 216 of the second hearing device 202 is also based on the first microphone signal provisioned by the first hearing device 102 because the first microphone signal is transmitted wirelessly from the first hearing device 102 to the second hearing device 202. In the illustrated embodiments, the mixer 220 of the second hearing device 202 provides a mixer output that is based on both microphone signal from the second microphone system 212 of the second hearing device 202, and also based microphone signal from the first microphone system 112 of the first hearing device 102. As a result, the user of the hearing system 100 receives audio output representing both (1) sound from the side (left side or right side) of the user wearing the second hearing device 202, and (2) sound from the other side of the user. This second system mode may be desirable in the situation in which the side of the user wearing the first hearing device 102 wants to hear sound from both sides of the user. In this situation, to allow the sound from the side of the user wearing the first hearing device 102 to be combined with sound at the other side of the user wearing the second hearing device 202, user may operate the system 100 to enter into the second system mode.

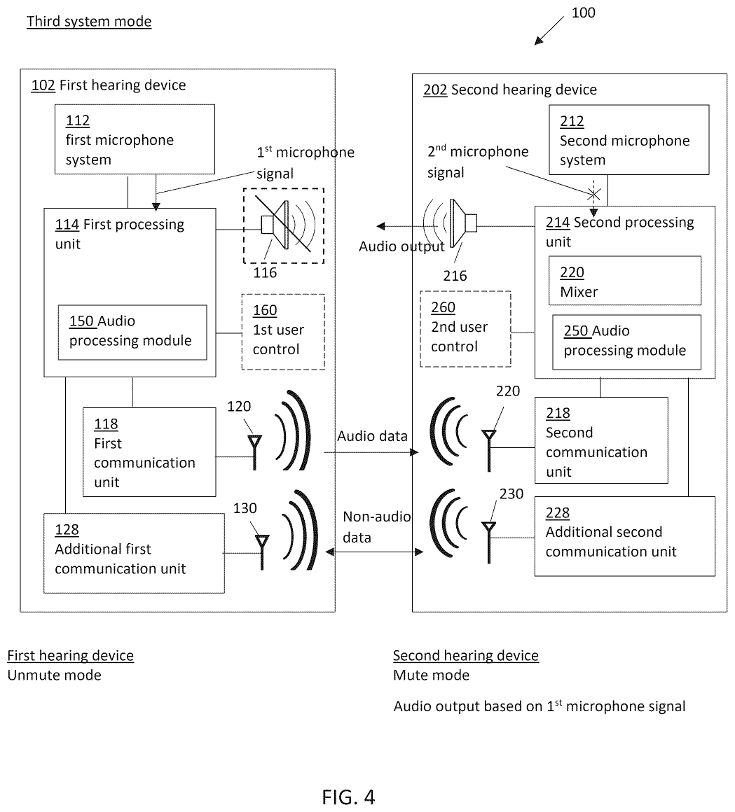

FIG. 4 illustrates the hearing system 100 of FIG. 1 being in a third system mode, with the first hearing device 102 being in an unmute mode, and the second hearing device 202 being in a mute mode. This third system mode allows the “good” ear at one side (wearing the second hearing device 202) of the user to hear sound captured from the other side of the user (the side wearing the first hearing device 102), and not sound from the “good” ear side of the user. As shown in the figure, when the hearing system 100 is in the third system mode, the first hearing device 102 transmits microphone signal to the second hearing device 202 due to the wireless communication link between the first antenna 120 of the first hearing device 102 and the second antenna 220 of the second hearing device 202 being maintained (not disabled). This allows the first microphone signal (representing sound captured from the side of the user wearing the first hearing device 102) provided by the first microphone 112 of the first hearing device 102 to be transmitted from the first hearing device 102 to the second hearing device 202 via the first antenna 120. Also, when the hearing system 100 is in the third system mode, the audio output by the receiver 216 of the second hearing device 202 is based on the first microphone signal transmitted from the first hearing device 102, and is not based on any microphone signal from the second microphone system 212 of the second hearing device 202. In the illustrated embodiments, the mixer 220 of the second hearing device 202 provides a mixer output that is based on microphone signal from the first microphone system 112 of the first hearing device 102, and not based on any microphone signal from the second microphone system 212 of the second hearing device 202. As a result, the user of the hearing system 100 receives audio output representing sound from the side (left side or right side) of the user wearing the first hearing device 102, and not sound from the other side of the user. This third system mode may be desirable in the situation in which the side of the user wearing the second hearing device 202 may have too much noise, or may have undesirable noise. In this situation, to prevent the unwanted noise (at the side of the user wearing the second hearing device 202) from being combined with desirable sound at the side of the user wearing the first hearing device 102, the user may then operate the system 100 to enter into the third system mode.

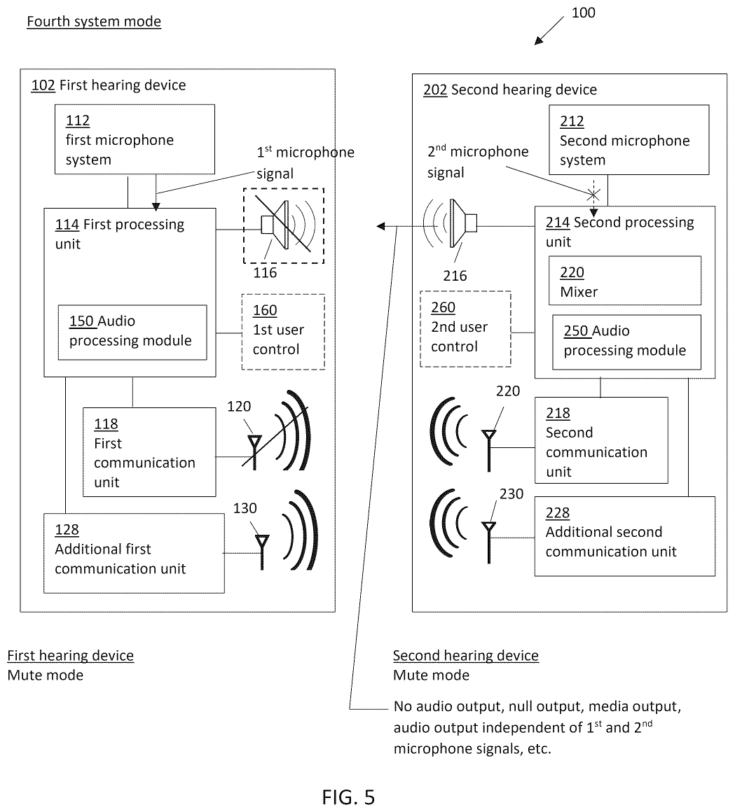

FIG. 5 illustrates the hearing system 100 of FIG. 1 being in a fourth system mode, with the first hearing device 102 being in a mute mode, and the second hearing device 202 being in a mute mode. This fourth system mode allows the “good” ear at one side (wearing the second hearing device 202) of the user to mute out sound captured by the second hearing device 202, and also to mute out sound captured from the other side of the user (the side wearing the first hearing device 102). As shown in the figure, when the hearing system 100 is in the fourth system mode, the first hearing device 102 does not transmit any microphone signal to the second hearing device 202 due to the wireless communication link between the first antenna 120 of the first hearing device 102 and the second antenna 220 of the second hearing device 202 being disabled. Also, when the hearing system 100 is in the fourth system mode, the audio output by the receiver 216 of the second hearing device 202 is not based on any first microphone signal from the first hearing device 102, and is not based on any microphone signal from the second microphone system 212 of the second hearing device 202. In the illustrated embodiments, the mixer 220 of the second hearing device 202 provides no output, or a null output. As a result, the user of the hearing system 100 receives no audio output representing sound from the side (left side or right side) of the user wearing the first hearing device 102, and no audio output representing sound from the other side of the user. This fourth system mode may be desirable in the situation in which both sides (left and right sides) of the user wearing the first and second hearing devices 102, 202, respectively, may have too much noise, or may have undesirable noise. In this situation, to prevent the unwanted noise from both sides of the user from being heard by the good (or better) ear of user, the user may then operate the system 100 to enter into the fourth system mode.

In some cases, when the hearing system 100 is in the fourth system mode, the second hearing device 202 may receive audio signals from an exterior device (not the first hearing device 102), and may provide audio output by the receiver 216 based on the received audio signals. By means of non-limiting examples, the exterior device may be a smart phone, a TV streamer, a MP3 player, an audio streaming device, a radio, a broadcasting device, a remote wireless microphone, a computer, etc. In some embodiments, audio signals from the exterior device may be transmitted wirelessly and received by the antenna 230 of the second hearing device 202, and may optionally be processed by the second processing unit 214 of the second hearing device 202 for output by the receiver 216. In the illustrated example, the mixer 220 of the second hearing device 202 may provide a mixer output that is media output provided by the exterior device, and/or that is an audio signal independent of any microphone signal from the second microphone system 212 of the second hearing device 202, and independent of any microphone signal from the first microphone system 112 of the first hearing device 102. The above feature is advantageous because it allows the user to focus on the audio signal from the exterior device without hearing ambient sound (e.g., noise) surrounding the user. In one example, the audio signal may be from a smart phone, and the fourth system mode will allow the user to hear phone conversations more clearly without interference due to sound surrounding the user. In another example, the audio signal may be from a TV streamer, remote wireless microphone, or MP3 player, and the fourth system mode will allow the user to hearing media content from the TV streamer, the remote wireless microphone, or the MP3 player without interference due to sound surrounding the user.

It should be noted that the hearing system 100 is not limited to providing audio output based on audio signals received from the external device when the hearing system 100 is in the fourth system mode, and that the hearing system 100 may also provide audio output based on audio signals received from the external device when the hearing system 100 is in other system modes (e.g., first system mode, second system mode, and/or third system mode).

In some embodiments, the second processing unit 214 of the second hearing device 202 may be configured to determine whether the second hearing device 202 is in communication with an external device (e.g., smart phone, TV streamer, MP3 player, remote wireless microphone, etc.) via the antenna 230. If so, then the mixer 220 of the second hearing device 202 incorporates the audio signal received from the external device into the output of the mixer 220, and the receiver 216 then provides audio output based on the output of the mixer 220 so that the audio signals from the external device can be presented to the user via the receiver 216.

In some embodiments, a gain may be applied for the first microphone signal and/or a gain may be applied for the second microphone signal, before they are input to the receiver 216. For example, when the hearing system 100 is in the first system mode (first hearing device 102 is muted, and the second hearing device 202 is unmuted), the audio processing module 250 of the second processing unit 214 may be configured to apply a gain factor of 1.0 (100%) for the microphone signal from the second microphone system 212. The mixer 220 then outputs the gain-applied signal as the mixer output. As another example, when the hearing system 100 is in the second system mode (first hearing device 102 is unmuted, and the second hearing device 202 is unmuted), the audio processing module 250 of the second processing unit 214 may be configured to apply a first gain factor of 0.5 (or any of other values less than 1.0) for the first microphone signal from the first microphone system 112 of the first hearing device 102, and a second gain factor of 0.5 (or any of other values less than 1.0) for the second microphone signal from the second microphone system 202 of the second hearing device 202. The mixer 220 then combines the gain-applied signals and output the combined signals as the mixer output. As another example, when the hearing system 100 is in the third system mode (first hearing device 102 is unmuted, and the second hearing device 202 is muted), the audio processing module 250 of the second processing unit 214 may be configured to apply a gain factor of 1.0 for the microphone signal from the first microphone system 112 of the first hearing device 102. The mixer 220 then outputs the gain-applied signal as the mixer output.

Also, in some embodiments, when the user is using the second hearing device 202 to listen to media content or phone conversation, the audio processing module 250 of the second processing unit 214 may be configured to apply a gain factor to the media content or the phone audio signal, so that the user can hear the media content or the phone conversation more clearly with respect to environmental sound. For example, when the hearing system 100 is in the first system mode (first hearing device muted, and the second hearing device unmuted), and if the user is also listening to media content or a phone conversation while the hearing system 100 is in the first system mode, the audio processing module 250 of the second processing unit 214 may be configured to apply a gain factor of 0.7 to the media content/phone signals, and a gain factor of 0.3 to the microphone signal from the second microphone system 212 of the second hearing device 202. The mixer 220 combines these gain-applied audio signals, and provide a mixer output accordingly. As another example, when the hearing system 100 is in the third system mode (first hearing device unmuted, and the second hearing device muted), and if the user is also listening to media content or a phone conversation while the hearing system 100 is in the third system mode, the audio processing module 250 of the second processing unit 214 may be configured to apply a gain factor of 0.7 to the media content/phone signals, and a gain factor of 0.3 to the microphone signal from the first microphone system 112 of the first hearing device 102. The mixer 220 combines these gain-applied audio signals, and provide a mixer output accordingly.

Also, in some embodiments, the gain factors to be applied to microphone signals from the first hearing device 102 and second hearing device 202 in different hearing system operation modes may be configurable by a user or health care professional. For example, the user may utilize an application installed at the user's smart phone to adjust the gain factor for microphone signals from the first hearing device 102, and/or to adjust the gain factor for microphone signals from the second hearing device 202, in different operational situations.

In the above example, the wireless communication link between the first hearing device 102 and the second hearing device 202 is described as being disabled when the user operates a user control (e.g., user control 160/260) to place the first hearing device 102 in a mute mode. In other cases, the disabling of the wireless communication link and/or the muting of the first hearing device 102 may occur automatically without requiring a user input. For example, in some cases, the disabling of the wireless communication link and/or the muting of the first hearing device 102 may occur automatically when a detected battery level of the first hearing device 102 and/or a detected battery level of the second hearing device 202 is below a threshold. In further cases, the disabling of the wireless communication link and/or the muting of the first hearing device 102 may occur after a detection of a condition (e.g., low battery level) and after receiving a confirmation from the user confirming that it is acceptable to disable the wireless communication link and/or to mute the first hearing device 102.

In some embodiments, the first processing unit 114 of the first hearing device 102 may determine whether a battery level of the first hearing device 102 is below a threshold, and may place the first hearing device 102 in a mute mode if the battery level is below the threshold. Optionally, the first hearing device 102 may send a notification to the second hearing device 202 to inform the second hearing device 202 that the wireless communication link will be disabled before the first hearing device 102 disables the wireless communication link (as described herein). In some cases, the placing of the hearing device 102 in the mute mode may occur automatically without requiring a user input, or may occur after providing a low-battery notification to the user, and after receiving confirmation from the user that it is acceptable to place the first hearing device 102 in a mute mode.

In some embodiments, the second processing unit 214 of the second hearing device 202 may determine whether a battery level of the second hearing device 202 is below a threshold, and may disable the wireless communication link (e.g., by disabling the second communication unit 218, and/or by sending a control signal to the first hearing device 102 to cause the first hearing device 102 to disable the first communication unit 118—either or both of which will place the first hearing device 102 in a mute mode) if the battery level of the second hearing device 202 is below the threshold. Also, in some embodiments, the second hearing device 202 may receive a battery level indication from the first hearing device 102, indicating a battery level of the first hearing device 102. In such cases, the second hearing device 202 may determine whether the battery level of the first hearing device 102 is below a threshold, and may disable the wireless communication link (e.g., by disabling the second communication unit 218, and/or by sending a control signal to the first hearing device 102 to cause the first hearing device 102 to disable the first communication unit 118—either or both of which will place the first hearing device 102 in a mute mode) if the battery level of the first hearing device 102 is below the threshold. In some cases, the placing of the hearing device 102 in the mute mode may occur automatically without requiring a user input, or may occur after providing a low-battery notification to the user, and after receiving confirmation from the user that it is acceptable to place the first hearing device 102 in a mute mode.

Although the hearing system 100 has been described as having the second hearing device 202 that comprises the second microphone system 212, in other cases, the second hearing device 202 may not include the second microphone system 212 or may have the second microphone system 212 disabled. Such configuration may be desirable when the ear of the user wearing the second hearing device 202 has no hearing deficiency (e.g., normal hearing), and the user just needs additional audio from the deaf side (e.g., to overcome head shadow). In such hearing system 100, the second hearing device 202 does not occlude the ear canal of the user (e.g., may have an open-dome configuration) which allows the user to directly hear sound from the environment. Also, in such hearing system 100, the second hearing device 202 may not have a mute mode and an unmute mode, because the second hearing device 202 always allow sound from the environment to be heard by the good ear of the user. Such hearing system 100 may have only a first system mode and a second system mode. In particular, when the first hearing device 102 is in the mute mode, the system 100 is in the first system mode, and the wireless communication link between the first hearing device 102 and the second hearing device 202 is disabled. When the first hearing device 102 is in the unmute mode, the system 100 is in the second system mode, and the wireless communication link between the first hearing device 102 and the second hearing device 202 is not disabled, thereby allowing microphone signals from the first hearing device 102 to be transmitted to the second hearing device 202.

For example, such a hearing system 100 may include: a first hearing device configured for wear at a first ear of a user; and a second hearing device configured for wear at a second ear of the user; wherein the first hearing device comprises a first microphone system configured to provide a first microphone signal, a first processing unit, a first communication unit, and a first antenna coupled to the first communication unit; wherein the second hearing device comprises a second processing unit, a second communication unit, a second antenna coupled to the second communication unit, and a receiver configured to provide an audio output; wherein the first hearing device has a first operation mode, and a second operation mode; wherein the first hearing device is configured to transmit the first microphone signal or audio signal based on the first microphone signal to the second hearing device via a wireless communication link between the first antenna of the first hearing device and the second antenna of the second hearing device when the first hearing device is in the first operation mode; and wherein when the first hearing device is in the second operation mode, the wireless communication link is disabled.

Also, for example, in such a hearing system 100, the second hearing device 202 may be a hearing device configured to communicate with another hearing device, the other hearing device configured for wear at a first ear of a user, the hearing device configured for wear at a second ear of the user, the hearing device includes: a processing unit; a communication unit; an antenna coupled to the communication unit; and a receiver; wherein the processing unit is configured to determine if a wireless communication link between the hearing device and the other hearing device is disabled or not, and to provide: (1) a first output that is not based on any microphone signal from the other hearing device, if the processing unit determines that the wireless communication link is disabled, or (2) a second output that is based on a microphone signal from the other hearing device, if the processing unit determines that the wireless communication link is not disabled; wherein the receiver is configured to provide an audio output based on the first output or the second output.

### Method Performed by First Hearing Device

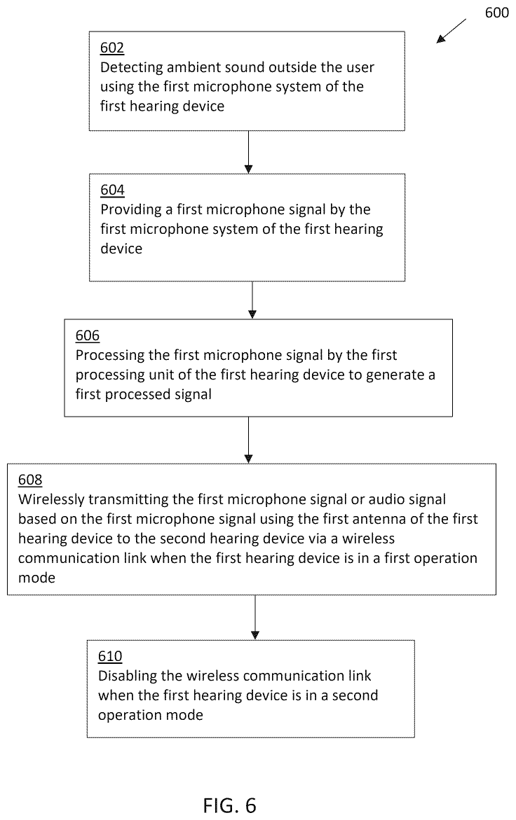

FIG. 6 illustrates a method 600 performed by the first hearing device 102 of FIG. 1 in accordance with some embodiments. The first hearing device 102 in the method 600 is for wear at an ear that has complete hearing loss or substantial hearing loss. If the first hearing device 102 has the receiver 116, the receiver 116 may be disabled (e.g., by a fitter or healthcare professional). In other cases, the first hearing device 102 may not include the receiver 116. Thus, the first hearing device 102 is configured to provide no audio output for the ear of the user wearing the first hearing device 102, regardless of which operation mode the first hearing device 102 is in.

The method 600 includes: detecting ambient sound outside the user using the first microphone system 112 of the first hearing device 102 (item 602), providing a first microphone signal by the first microphone system 112 of the first hearing device 102 (item 604), processing the first microphone signal by the first processing unit 114 of the first hearing device 102 to generate a first processed signal (item 606), wirelessly transmitting the first microphone signal or audio signal based on the first microphone signal using the first antenna 120 of the first hearing device 102 to the second hearing device 202 via a wireless communication link when the first hearing device 102 is in a first operation mode (item 608), and disabling the wireless communication link when the first hearing device 102 is in a second operation mode (item 610).

In some embodiments, the method 600 may include receiving a user input for placing the first hearing device 102 in the first operation mode.

In some embodiments, the method 600 may include receiving a user input for placing the first hearing device 102 in the second operation mode.

In some embodiments, the method 600 may include determining whether a battery level is below a threshold, and placing the first hearing device 102 in a mute mode if the battery level is below the threshold. Optionally, the method 600 may include sending a notification to the second hearing device 202 to inform the second hearing device 202 that the wireless communication link will be disabled before the first hearing device 102 disables the wireless communication link (as described herein).

In some embodiments, in the method 600, the first operation mode may be a unmute mode.

In some embodiments, in the method 600, the second operation mode may be a mute mode.

In some embodiments, item 610 may be performed before item 602, before item 604, before item 606, or before item 608. In other embodiments, item 610 may be performed at any time that is independent of item 602, item 604, item 606, item 608, or any combination of the foregoing.

### Method Performed by Second Hearing Device

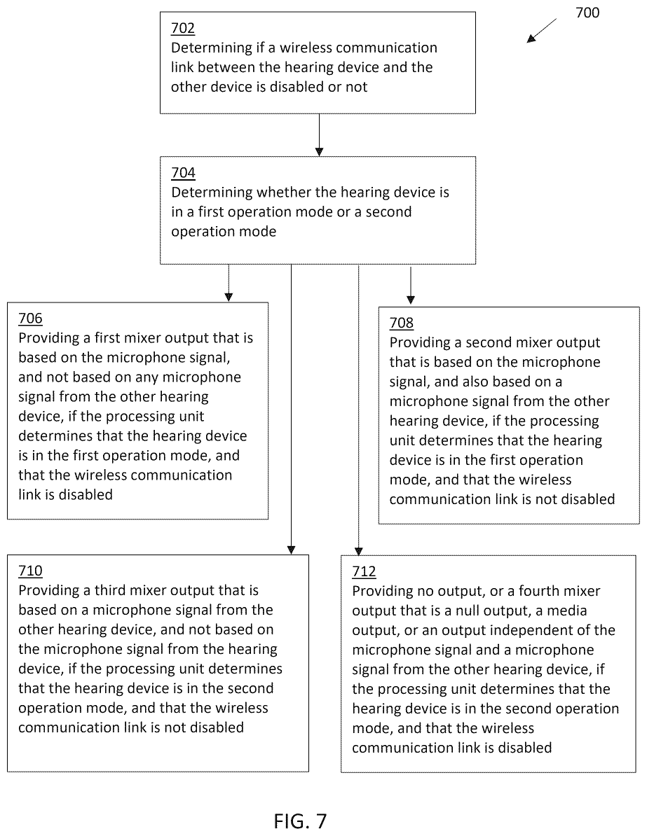

FIG. 7 illustrates a method 700 performed by the second hearing device 202 of FIG. 1 in accordance with some embodiments. The second hearing device 202 in the method 700 is for wear at an ear that opposite from the ear having complete hearing loss or substantial hearing loss, or is for wear at an ear having less hearing loss compared to the contralateral ear.

The method 700 includes: determining, by the second processing unit 214 of the second hearing device 202, if a wireless communication link between the second hearing device 202 and the first hearing device 102 is disabled or not (item 702); and determining, by the second processing unit 214, whether the second hearing device 202 is in a first operation mode or a second operation mode (item 704). The method 700 also includes: providing a first mixer output that is based on a microphone signal (e.g., from the second microphone system 212 of the second hearing device 202), and not based on any microphone signal from the first hearing device 102, if the second processing unit 214 determines that the second hearing device 202 is in the first operation mode, and that the wireless communication link is disabled (item 706), or providing a second mixer output that is based on the microphone signal, and also based on a microphone signal from the first hearing device 102, if the second processing unit 214 determines that the second hearing device 202 is in the first operation mode, and that the wireless communication link is not disabled (item 708), or providing a third mixer output that is based on a microphone signal from the first hearing device 102, and not based on the microphone signal from the second hearing device 202, if the second processing unit 214 determines that the second hearing device 202 is in the second operation mode, and that the wireless communication link is not disabled (item 710), or providing no output, or a fourth mixer output that is a null output, a media output, or an output independent of the microphone signal and a microphone signal from the first hearing device 102, if the second processing unit 214 determines that the second hearing device 202 is in the second operation mode, and that the wireless communication link is disabled (item 712).

In some embodiments, the method 700 may include receiving a user input for placing the second hearing device 202 in the first operation mode.

In some embodiments, the method 700 may include receiving a user input for placing the second hearing device 202 in the second operation mode.

In some embodiments, in the method 700, the first operation mode may be a unmute mode.

In some embodiments, in the method 700, the second operation mode may be a mute mode.

In some embodiments, in the method 700, the second hearing device 202 may determine whether a battery level of the second hearing device 202 is below a threshold, and may disable the wireless communication link (e.g., by disabling the second communication unit 218, and/or by sending a control signal to the first hearing device 102 to cause the first hearing device 102 to disable the first communication unit 118—either or both of which will place the first hearing device 102 in a mute mode) if the battery level of the second hearing device 202 is below the threshold.

Also, in some embodiments, in the method 700, the second hearing device 202 may receive a battery level indication from the first hearing device 102, indicating a battery level of the first hearing device 102. In such cases, the second hearing device 202 may determine whether the battery level of the first hearing device 102 is below a threshold, and may disable the wireless communication link (e.g., by disabling the second communication unit 218, and/or by sending a control signal to the first hearing device 102 to cause the first hearing device 102 to disable the first communication unit 118—either or both of which will place the first hearing device 102 in a mute mode) if the battery level of the first hearing device 102 is below the threshold.

### Hearing Device Features

In one or more embodiments described herein, each of the first processing unit 114 and the second processing unit 214 may be implemented using hardware, software, or a combination of both. Hardware may include one or more processors, electronic components, circuit, intetrated circuit, etc. For examples, one or each of the first and second processing units 114, 214 may be a processor, an integrated circuit, an application, a functional module, etc., or any combination of the foregoing. The processing unit 114/214 may be implemented in a signal-processing chip or a printed circuit board (PCB) in some cases. The first processing unit 114 may be configured to process microphone signals from the first microphone system 112, and the second processing unit 214 may be configured to process microphone signals from the second microphone system 212. In some cases, if the second hearing device 202 is configured to provide hearing loss compensation, the second processing unit 214 may be configured to compensate for a hearing loss of the user, i.e., apply frequency dependent gain to input signals (e.g., microphone signals from the second microphone system 212) in accordance with the user's frequency dependent hearing impairment. One or each of the processing units 114, 214 may optionally be configured to perform feedback cancelation, beamforming, tinnitus reduction/masking, noise reduction, noise cancellation, speech recognition, bass adjustment, treble adjustment, processing of user input, or any combination of two or more of the foregoing. The second processing unit 214 of the second hearing device 202 may be configured to provide an electric output signal based on a processing of microphone signal(s) from the second microphone system 212, processing of microphone signal(s) from the first microphone system 112 of the first hearing device 102, processing of media audio content, processing of phone signals, or any combination of the foregoing.

In one or more embodiments described herein, one or each of the hearing devices 102, 202 may optionally include a memory (non-transitory medium) that can be accessed by the processing unit of the corresponding hearing device. In one implementation, the memory may be a processor-readable medium. The memory may be a volatile or a non-volatile memory. The memory may store a first operation mode indicator of the first hearing device 102 and/or a second operation mode indicator of the second hearing device 202. The memory may also store gain factor(s) for application to different audio signals, as described herein.

The antenna 130 and/or the antenna 230 may be any antenna configured to communicate with an accessory device. In some cases, each of the antennas 130, 230 may be an electric antenna configured for wireless communication at a frequency. By means of non-limiting examples, the frequency may be above 800 MHZ, anywhere between 900 MHZ and 6 GHZ, anywhere from 902 MHz to 928 MHz, anywhere from 2.4 GHz to 2.5 GHZ, anywhere from 5.725 GHz to 5.875 GHz, etc. In other cases, each of the antennas 130, 230 may be a magnetic antenna having a magnetic core and a coil around the magnetic core.

The first microphone system 112 may include one or more microphone(s). Similarly, the second microphone system 212 may include one or more microphone(s). Optionally, one or each of the hearing devices 102, 202 may optionally further include one or more input transducers. The one or more input transducers may comprise one or more vibration sensors configured for detecting bone vibration. The one or more input transducer(s) may be configured for converting an acoustic signal into a first electric input signal. The first electric input signal may be an analogue signal. The first electric input signal may be a digital signal. The one or more input transducer(s) may be coupled to one or more analogue-to-digital converter(s) configured for converting the analogue first input signal into a digital first input signal.

Although the communication units 118, 128 are shown as separate items from the first processing unit 114, in other embodiments, one or both of the communication units 118, 128 may be implemented as a part of the first processing unit 114, or as another processing unit. Similarly, in other embodiments, one or both of the communication units 218, 228 in the second hearing device 202 may be implemented as a part of the second processing unit 214, or as another processing unit. In some embodiments, each of the communication units 118, 128, 220, 230 may be configured for converting a wireless signal received by the antenna into an electric input signal, and/or for converting an electric output signal into a wireless signal for transmission by the antenna. In some cases, the communication unit 228 of the second hearing device 202 may be configured to receive control signal from an external device received via the antenna 230. The control signal may be used by the processing unit 214 to control an operation of the second hearing device 202 (e.g., to mute or unmute the second hearing device 202, adjust a gain, change a hearing program, etc.). Alternatively or additionally, the communication unit 228 may be configured to receive media (e.g., music, radio, TV audio) or phone signals via the antenna 230, thereby enabling the user to listen to media and/or enabling the user to perform phone calls. Similarly, the communication unit 128 of the first hearing device 102 may be configured to receive control signal from an external device received bia the antenna 130. The control signal may be used by the processing unit 114 to control an operation of the first hearing device 102 (e.g., to mute or unmute the first hearing device 102, adjust a gain, etc.). Also, in some embodiments, the communication unit 218 of the second hearing device 202 may be configured to receive audio signal (microphone signals or signals derived from microphone signal) received via the antenna 220 and transmitted by the antenna 120. In addition, in some embodiments, the communication unit 128 and the communication unit 228 may be configured to communicate control signals (e.g., operation parameter, operation mode indicator, etc.) that are non-audio data with each other. For example, after the first hearing device 102 is muted, the first hearing device 102 may transmit an operation mode indicator (indicating that the first hearing deice 102 is muted) via the antenna 130 for reception by the antenna 230. As another example, after the first hearing device 102 is unmuted, the first hearing device 102 may transmit an operation mode indicator (indicating that the first hearing deice 102 is unmuted) via the antenna 130 for reception by the antenna 230.

The receiver 216 of the second hearing device 202 may be a loudspeaker. The receiver 216 may be configured for converting electric output signal (e.g., mixer output signal from mixer 220, output signal from the second processing unit 214, etc.) into an acoustic output signal. In some cases, if the second hearing device 202 is configured to provide hearing loss compensation, the receiver 216 may be configured to convert an electric output signal (provided by the second processing unit 214 or another processing unit) representing a hearing loss compensated signal, into an acoustic output signal. The receiver 216 may be comprised in an ITE unit or in an earpiece, e.g. Receiver-in-Ear (RIE) unit or Microphone-and-Receiver-in-Ear (MaRIE) unit, of the hearing device.

In an embodiment, each of the hearing devices 102, 202 may comprise a power source. The power source may comprise a battery providing a first voltage. The battery may be a rechargeable battery. The battery may be a replaceable battery. The power source may comprise a power management unit. The power management unit may be configured to convert a first voltage into a second voltage. The power source may comprise a charging coil.

In any of the examples described herein, one or each of the hearing devices 102, 202 may be custom fitted, standard fitted, non-fitted, open fitted, occlusive fitted.

As used in this specification, the terms “first”, “second”, “third”, etc. are used to identify different items, and they do not refer to an ordering of the items unless stated explicitly.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications and equivalents.

### Items

Item 1. A hearing system comprising:
a first hearing device configured for wear at a first ear of a user; and
a second hearing device configured for wear at a second ear of the user;
wherein the first hearing device comprises a first microphone system configured to provide a first microphone signal, a first processing unit, a first communication unit, and a first antenna coupled to the first communication unit;
wherein the second hearing device comprises a second microphone system configured to provide a second microphone signal, a second processing unit, a second communication unit, a second antenna coupled to the second communication unit, and a receiver configured to provide an audio output;
wherein the first hearing device has a first operation mode, and a second operation mode;
wherein the first hearing device is configured to transmit the first microphone signal or audio signal based on the first microphone signal to the second hearing device via a wireless communication link between the first antenna of the first hearing device and the second antenna of the second hearing device when the first hearing device is in the first operation mode; and
wherein when the first hearing device is in the second operation mode, the wireless communication link is disabled.
   Item 2. The hearing system of item 1, wherein when the first hearing device is in the second operation mode, the first hearing device remains on while the wireless communication link is disabled.
   Item 3. The hearing system of item 1, wherein the hearing system has a first system mode, and wherein when the hearing system is in the first system mode, the audio output from the receiver of the second hearing device is based on the second microphone signal and not based on the first microphone signal.
   Item 4. The hearing system of item 3, wherein the first system mode is defined by the first hearing device being in the second operation mode, and by the second hearing device being in an unmute mode.
   Item 5. The hearing system of item 3, wherein when the hearing system is in the first system mode, the first communication unit and/or the first antenna of the first hearing device is disabled to disable the wireless communication link.
   Item 6. The hearing system of item 3, wherein the second hearing device comprises a mixer, and wherein the mixer of the second hearing device is configured to provide an output that is based on the second microphone signal, not based on the first microphone signal, when the hearing system is in the first system mode.
   Item 7. The hearing system of item 3, wherein the hearing system has a second system mode, and wherein when the hearing system is in the second system mode, the audio output from the receiver of the second hearing device is based on the first microphone signal transmitted from the first hearing device to the second hearing device, and also based on the second microphone signal from the second microphone of the second hearing device.
   Item 8. The hearing system of item 7, wherein the second system mode is defined by the first hearing device being in the first operation mode, and by the second hearing device being in an unmute mode.
   Item 9. The hearing system of item 7, wherein when the hearing system is in the second system mode, the first communication unit and/or the first antenna of the first hearing device is not disabled to maintain the wireless communication link.
   Item 10. The hearing system of item 7, wherein the second hearing device comprises a mixer, and wherein the mixer of the second hearing device is configured to provide an output that is based on the second microphone signal and the first microphone signal, when the hearing system is in the second system mode.
   Item 11. The hearing system of item 7, wherein the hearing system has a third system mode, and wherein when the hearing system is in the third system mode, the audio output from the receiver of the second hearing device is based on the first microphone signal and not based on the second microphone signal.
   Item 12. The hearing system of item 11, wherein the third system mode is defined by the first hearing device being in the first operation mode, and by the second hearing device being in a mute mode.
   Item 13. The hearing system of item 11, wherein when the hearing system is in the third system mode, the first communication unit and/or the first antenna of the first hearing device is not disabled to maintain the wireless communication link.
   Item 14. The hearing system of item 11, wherein the second hearing device comprises a mixer, and wherein the mixer of the second hearing device is configured to provide an output that is based on the first microphone signal, not based on the second microphone signal, when the hearing system is in the third system mode.
   Item 15. The hearing system of item 11, wherein the hearing system has a fourth system mode, and wherein when the hearing system is in the fourth system mode, the audio output from the receiver of the second hearing device is independent of the first microphone signal from the first microphone of the first hearing device, and is independent of the second microphone signal from the second microphone of the second hearing device.
   Item 16. The hearing system of item 15, wherein the fourth system mode is defined by the hearing device being in the second operation mode, and by the second hearing device being in a mute mode.
   Item 17. The hearing system of item 15, wherein when the hearing system is in the fourth system mode, the first communication unit and/or the first antenna of the first hearing device is disabled to disable the wireless communication link.
   Item 18. The hearing system of item 15, wherein the second hearing device comprises a mixer, and wherein the mixer of the second hearing device is configured to provide an output that is not based on the second microphone signal, and is not based on the first microphone signal, when the hearing system is in the fourth system mode.
   Item 19. The hearing system of item 1, further comprising a user-control configured to allow the user to mute the first hearing device, to mute the second hearing device, or to mute both the first hearing device and the second hearing device.
   Item 20. The hearing system of item 19, wherein the user-control comprises a first control at the first hearing device and a second control at the second hearing device.
   Item 21. The hearing system of item 19, wherein the user-control is at a handheld device that is configured to wirelessly communicate with the first hearing device and/or the second hearing device.
   Item 22. The hearing system of item 1, wherein the first hearing device is configured to disable the wireless communication link.
   Item 23. The hearing system of item 22, wherein the first hearing device is configured to communicate with the second hearing device to inform the second hearing device before disabling the wireless communication link.
   Item 24. The hearing system of item 1, wherein the second hearing device comprises a mixer.
   Item 25. The hearing system of item 24, wherein the mixer of the second hearing device is configured to provide a mixer output that is based on (1) the first microphone signal or the audio signal from the first hearing device, and (2) the second microphone signal from the first hearing device, when the first hearing device is in the first operation mode, and when the second hearing device is in an unmute mode.
   Item 26. The hearing system of item 24, wherein the mixer of the second hearing device is configured to provide a mixer output that is based on only the second microphone signal from the second microphone of the second hearing device, when the first hearing device is in the second operation mode, and when the second hearing device is in an unmute mode.
   Item 27. The hearing system of item 24, wherein the mixer of the second hearing device is configured to provide a mixer output that is based on only the first microphone signal from the first microphone of the first hearing device or only the audio signal, when the first hearing device is in the first operation mode, and when the second hearing device is in a mute mode.
   Item 28. The hearing system of item 24, wherein the mixer of the second hearing device is configured to provide no output, a null output, a media output, or an output that is independent of the first microphone signal and the second microphone signal, when the first hearing device is in the second operation mode, and when the second hearing device is in a mute mode.
   Item 29. The hearing system of item 1, wherein when the first hearing device is in the second operation mode, the first communication unit and/or the first antenna is disabled by reducing or removing power supplied to the first communication unit and/or to the first antenna.
   Item 30. The hearing system of item 1, wherein when the first hearing device is in the second operation mode, the first communication unit and/or the first antenna is disabled by an operation of a switch inside the hearing device.
   Item 31. The hearing system of item 1, wherein when the first hearing device is in the second operation mode, the second communication unit of the second hearing device is in a standby mode.
   Item 32. The hearing system of item 1, wherein the first operation mode of the first hearing device is an unmute mode, and the second operation mode of the first hearing device is a mute mode.
   Item 33. The hearing system of item 1, wherein the first antenna of the first hearing device comprises a magnetic induction antenna.
   Item 34. The hearing system of item 33, wherein the magnetic induction antenna is configured to transmit the first microphone signal or the audio signal as audio data.
   Item 35. The hearing system of item 33, wherein the first hearing device further comprises an additional first antenna configured to communicate with an exterior device.
   Item 36. The hearing system of item 35, wherein the exterior device comprises a remote control, a phone, or a watch, a tablet, a computer, or a communication device.
   Item 37. The hearing system of item 35, wherein the additional first antenna of the first hearing device is configured to provide communication at 2.4 GHz.
   Item 38. The hearing system of item 35, wherein the additional first antenna of the first hearing device is configured to communicate non-audio data with the second hearing device.
   Item 39. The hearing system of item 38, wherein the non-audio data comprises control data.
   Item 40. The hearing system of item 38, wherein the second hearing device comprises an additional second antenna configured to communicate with the additional first antenna of the first hearing device.
   Item 41. A hearing device configured for wear at a first ear of a user, wherein the hearing device is configured to communicate with another hearing device that is configured for wear at a second ear of the user, the hearing device comprising:
a first microphone system configured to provide a first microphone signal;
a first processing unit;
a first communication unit; and
a first antenna coupled to the first communication unit;
wherein the hearing device has a first operation mode, and a second operation mode;
wherein the hearing device is configured to transmit the first microphone signal or audio signal based on the first microphone signal to the other hearing device via a wireless communication link between the hearing device and the other hearing device when the hearing device is in the first operation mode; and
wherein when the hearing device is in the second operation mode, the wireless communication link is disabled.
   Item 42. The hearing device of item 41, wherein when the hearing device is in the second operation mode, the hearing device remains on while the wireless communication link is disabled.
   Item 43. The hearing device of item 41, further comprising a user-control configured to allow the user to mute the hearing device.
   Item 44. The hearing device of item 43, wherein the user-control is at a handheld device that is configured to wirelessly communicate with the hearing device.
   Item 45. The hearing device of item 41, wherein the hearing device is configured to disable the wireless communication link.
   Item 46. The hearing device of item 45, wherein the hearing device is configured to communicate with the other hearing device to inform the other hearing device before disabling the wireless communication link.
   Item 47. The hearing device of item 41, wherein when the hearing device is in the second operation mode, the first communication unit and/or the first antenna is disabled by reducing or removing power supplied to the first communication unit and/or to the first antenna.
   Item 48. The hearing device of item 41, wherein when the hearing device is in the second operation mode, the first communication unit and/or the first antenna is disabled by an operation of a switch inside the hearing device.
   Item 49. The hearing device of item 41, wherein when the hearing device is in the second operation mode, the second communication unit of the other hearing device is in a standby mode.
   Item 50. The hearing device of item 41, wherein the first operation mode of the hearing device is an unmute mode, and the second operation mode of the hearing device is a mute mode.
   Item 51. The hearing device of item 41, wherein the first antenna of the hearing device comprises a magnetic induction antenna.
   Item 52. The hearing device of item 51, wherein the magnetic induction antenna is configured to transmit the first microphone signal or the audio signal as audio data.
   Item 53. The hearing device of item 51, further comprising an additional first antenna configured to communicate with an exterior device.
   Item 54. The hearing device of item 53, wherein the exterior device comprises a remote control, a phone, or a watch, a tablet, a computer, or a communication device.
   Item 55. The hearing device of item 53, wherein the additional first antenna of the hearing device is configured to provide communication at 2.4 GHz.
   Item 56. The hearing device of item 53, wherein the additional first antenna of the hearing device is configured to communicate non-audio data with the other hearing device.
   Item 57. The hearing device of item 56, wherein the non-audio data comprises control data.
   Item 58. The hearing device of item 41, further comprising an additional antenna for communicating control data with the other hearing device.
   Item 59. A hearing device configured to communicate with another hearing device, the other hearing device configured for wear at a first ear of a user, the hearing device configured for wear at a second ear of the user, the hearing device comprising:
a microphone system configured to provide a microphone signal;
a processing unit comprising a mixer;
a communication unit; and
an antenna coupled to the communication unit;
wherein the processing unit is configured to determine if a wireless communication link between the hearing device and the other hearing device is disabled or not, determine whether the hearing device is in a first operation mode or a second operation mode, and control the mixer to provide:
(1) a first mixer output that is based on the microphone signal, and not based on any microphone signal from the other hearing device, if the processing unit determines that the hearing device is in the first operation mode, and that the wireless communication link is disabled,
(2) a second mixer output that is based on the microphone signal, and also based on a microphone signal from the other hearing device, if the processing unit determines that the hearing device is in the first operation mode, and that the wireless communication link is not disabled,
(3) a third mixer output that is based on a microphone signal from the other hearing device, and not based on the microphone signal from the hearing device, if the processing unit determines that the hearing device is in the second operation mode, and that the wireless communication link is not disabled, or
(4) no output, or a fourth mixer output that is a null output, a media output, or an output independent of the microphone signal and a microphone signal from the other hearing device, if the processing unit determines that the hearing device is in the second operation mode, and that the wireless communication link is disabled.
   Item 60. The hearing device of item 59, further comprising a user-control configured to allow the user to mute the hearing device, to mute the other hearing device, or to mute both the hearing device and the other hearing device.
   Item 61. The hearing device of item 59, wherein the hearing device is configured to communicate with a handheld device having a user-control configured to allow the user to mute the hearing device, to mute the other hearing device, or to mute both the hearing device and the other hearing device.
   Item 62. The hearing device of item 60, wherein the hearing device is in the second operation mode when the hearing device is muted, and is in the first operation mode when the hearing device is unmuted.
   Item 63. The hearing device of item 59, wherein the hearing device is configured to receive a notification from the other hearing device before the other hearing device disales the wireless communication link.
   Item 64. The hearing device of item 59, wherein when wireless communication link is disabled, the communication unit of the hearing device is in a standby mode.
   Item 65. The hearing device of item 59, wherein the other hearing device is an unmute mode when the wireless communication link is not disabled, and is in a mute mode when the wireless communication link is disabled.
   Item 66. The hearing device of item 59, wherein the antenna of the hearing device comprises a magnetic induction antenna.
   Item 67. The hearing device of item 66, wherein the magnetic induction antenna is configured to receive an audio signal from the other hearing device, the audio signal being a microphone signal of the other hearing device, or based on a microphone signal of the other hearing device.
   Item 68. The hearing device of item 66, further comprising an additional first antenna configured to communicate with an exterior device.
   Item 69. The hearing device of item 68, wherein the exterior device comprises a remote control, a phone, or a watch, a tablet, a computer, or a communication device.
   Item 70. The hearing device of item 68, wherein the additional first antenna of the hearing device is configured to provide communication at 2.4 GHz.
   Item 71. The hearing device of item 68, wherein the additional antenna of the hearing device is configured to communicate non-audio data with the other hearing device.
   Item 72. The hearing device of item 71, wherein the non-audio data comprises control data.
   Item 73. The hearing device of item 71, further comprising an additional antenna configured to communicate control data with the other hearing device.
   Item 74. A hearing device configured to communicate with another hearing device, the other hearing device configured for wear at a first ear of a user, the hearing device configured for wear at a second ear of the user, the hearing device comprising:
a processing unit;
a communication unit;
an antenna coupled to the communication unit; and
a receiver;
wherein the processing unit is configured to determine if a wireless communication link between the hearing device and the other hearing device is disabled or not, and to provide:
(1) a first output that is not based on any microphone signal from the other hearing device, if the processing unit determines that the wireless communication link is disabled, or
(2) a second output that is based on a microphone signal from the other hearing device, if the processing unit determines that the wireless communication link is not disabled;
wherein the receiver is configured to provide an audio output based on the first output or the second output.
   Item 75. The hearing device of item 74, further comprising a microphone system that has been disabled.
   Item 76. The hearing device of item 74, further comprising a user-control configured to allow the user to mute the other hearing device.
   Item 77. The hearing device of item 74, wherein the hearing device is configured to receive a notification from the other hearing device before the other hearing device disales the wireless communication link.
   Item 78. The hearing device of item 74, wherein when wireless communication link is disabled, the communication unit of the hearing device is in a standby mode.
   Item 79. The hearing device of item 74, wherein the antenna of the hearing device comprises a magnetic induction antenna.
   Item 80. The hearing device of item 79, wherein the magnetic induction antenna is configured to receive an audio signal from the other hearing device, the audio signal being a microphone signal of the other hearing device, or based on a microphone signal of the other hearing device.
   Item 81. The hearing device of item 79, further comprising an additional first antenna configured to communicate with an exterior device.
   Item 82. The hearing device of item 81, wherein the exterior device comprises a remote control, a phone, or a watch, a tablet, a computer, or a communication device.
   Item 83. The hearing device of item 81, wherein the additional first antenna of the hearing device is configured to provide communication at 2.4 GHz.
   Item 84. The hearing device of item 81, wherein the additional antenna of the hearing device is configured to communicate non-audio data with the other hearing device.
   Item 85. The hearing device of item 84, wherein the non-audio data comprises control data.
   Item 86. The hearing device of item 84, further comprising an additional antenna configured to communicate control data with the other hearing device.

### LIST OF REFERENCES

100 hearing system
102 first hearing device
112 first microphone system
114 first processing unit
116 receiver
118 first communication unit
120 antenna
128 additional first communication unit
130 antenna
160 first user control
202 second hearing device
212 second microphone system
214 second processing unit
216 receiver
218 second communication unit
220 antenna
228 additional second communication unit
220 mixer
230 antenna
250 audio processing module
260 second user control
600 method
602 detecting ambient sound outside the user using the first microphone system of the first hearing device
604 providing a first microphone signal by the first microphone system of the first hearing device
606 processing the first microphone signal by the first processing unit of the first hearing device to generate a first processed signal
608 wirelessly transmitting the first microphone signal or audio signal based on the first microphone signal using the first antenna of the first hearing device to the second hearing device via a wireless communication link when the first hearing device is in a first operation mode
610 disabling the wireless communication link when the first hearing device is in a second operation mode
700 method
702 determining if a wireless communication link between the hearing device and the other device is disabled or not
704 determining whether the hearing device is in a first operation mode or a second operation mode
706 providing a first mixer output that is based on the microphone signal, and not based on any microphone signal from the other hearing device, if the processing unit determines that the hearing device is in the first operation mode, and that the wireless communication link is disabled
708 providing a second mixer output that is based on the microphone signal, and also based on a microphone signal from the other hearing device, if the processing unit determines that the hearing device is in the first operation mode, and that the wireless communication link is not disabled
710 providing a third mixer output that is based on a microphone signal from the other hearing device, and not based on the microphone signal from the hearing device, if the processing unit determines that the hearing device is in the second operation mode, and that the wireless communication link is not disabled
712 providing no output, or a fourth mixer output that is a null output, a media output, or an output independent of the microphone signal and a microphone signal from the other hearing device, if the processing unit determines that the hearing device is in the second operation mode, and that the wireless communication link is disabled

1. A hearing system comprising:
a first hearing device configured for wear at a first ear of a user; and
a second hearing device configured for wear at a second ear of the user;
wherein the first hearing device comprises a first microphone system configured to provide a first microphone signal, a first processing unit, a first communication unit, and a first antenna coupled to the first communication unit;
wherein the second hearing device comprises a second microphone system configured to provide a second microphone signal, a second processing unit, a second communication unit, a second antenna coupled to the second communication unit, and a receiver configured to provide an audio output;
wherein the first hearing device has a first operation mode, and a second operation mode;
wherein the first hearing device is configured to transmit the first microphone signal or audio signal based on the first microphone signal to the second hearing device via a wireless communication link between the first antenna of the first hearing device and the second antenna of the second hearing device when the first hearing device is in the first operation mode; and
wherein when the first hearing device is in the second operation mode, the wireless communication link is disabled.

2. The hearing system of claim 1, wherein when the first hearing device is in the second operation mode, the first hearing device remains on while the wireless communication link is disabled.

3. The hearing system of claim 1, wherein the hearing system has a first system mode, and wherein when the hearing system is in the first system mode, the audio output from the receiver of the second hearing device is based on the second microphone signal and not based on the first microphone signal.

4. The hearing system of claim 3, wherein the first system mode is defined by the first hearing device being in the second operation mode, and by the second hearing device being in an unmute mode.

5. The hearing system of claim 3, wherein when the hearing system is in the first system mode, the first communication unit and/or the first antenna of the first hearing device is disabled to disable the wireless communication link.

6. The hearing system of claim 3, wherein the second hearing device comprises a mixer, and wherein the mixer of the second hearing device is configured to provide an output that is based on the second microphone signal, not based on the first microphone signal, when the hearing system is in the first system mode.

7. The hearing system of claim 3, wherein the hearing system has a second system mode, and wherein when the hearing system is in the second system mode, the audio output from the receiver of the second hearing device is based on the first microphone signal transmitted from the first hearing device to the second hearing device, and also based on the second microphone signal from the second microphone of the second hearing device.

8. The hearing system of claim 7, wherein the second system mode is defined by the first hearing device being in the first operation mode, and by the second hearing device being in an unmute mode.

9. The hearing system of claim 7, wherein when the hearing system is in the second system mode, the first communication unit and/or the first antenna of the first hearing device is not disabled to maintain the wireless communication link.

10. The hearing system of claim 7, wherein the second hearing device comprises a mixer, and wherein the mixer of the second hearing device is configured to provide an output that is based on the second microphone signal and the first microphone signal, when the hearing system is in the second system mode.

11. The hearing system of claim 7, wherein the hearing system has a third system mode, and wherein when the hearing system is in the third system mode, the audio output from the receiver of the second hearing device is based on the first microphone signal and not based on the second microphone signal.

12. The hearing system of claim 11, wherein the third system mode is defined by the first hearing device being in the first operation mode, and by the second hearing device being in a mute mode.

13. The hearing system of claim 11, wherein when the hearing system is in the third system mode, the first communication unit and/or the first antenna of the first hearing device is not disabled to maintain the wireless communication link.

14. The hearing system of claim 11, wherein the second hearing device comprises a mixer, and wherein the mixer of the second hearing device is configured to provide an output that is based on the first microphone signal, not based on the second microphone signal, when the hearing system is in the third system mode.

15. The hearing system of claim 11, wherein the hearing system has a fourth system mode, and wherein when the hearing system is in the fourth system mode, the audio output from the receiver of the second hearing device is independent of the first microphone signal from the first microphone of the first hearing device, and is independent of the second microphone signal from the second microphone of the second hearing device.

16. The hearing system of claim 15, wherein the fourth system mode is defined by the hearing device being in the second operation mode, and by the second hearing device being in a mute mode.

17. The hearing system of claim 15, wherein when the hearing system is in the fourth system mode, the first communication unit and/or the first antenna of the first hearing device is disabled to disable the wireless communication link.

18. The hearing system of claim 15, wherein the second hearing device comprises a mixer, and wherein the mixer of the second hearing device is configured to provide an output that is not based on the second microphone signal, and is not based on the first microphone signal, when the hearing system is in the fourth system mode.

19. The hearing system of claim 1, further comprising a user-control configured to allow the user to mute the first hearing device, to mute the second hearing device, or to mute both the first hearing device and the second hearing device.

20. The hearing system of claim 19, wherein the user-control comprises a first control at the first hearing device and a second control at the second hearing device.

21. The hearing system of claim 19, wherein the user-control is at a handheld device that is configured to wirelessly communicate with the first hearing device and/or the second hearing device.

22. The hearing system of claim 1, wherein the first hearing device is configured to disable the wireless communication link.

23. The hearing system of claim 22, wherein the first hearing device is configured to communicate with the second hearing device to inform the second hearing device before disabling the wireless communication link.

24. The hearing system of claim 1, wherein the second hearing device comprises a mixer.

25. The hearing system of claim 24, wherein the mixer of the second hearing device is configured to provide a mixer output that is based on (1) the first microphone signal or the audio signal from the first hearing device, and (2) the second microphone signal from the first hearing device, when the first hearing device is in the first operation mode, and when the second hearing device is in an unmute mode.

26. The hearing system of claim 24, wherein the mixer of the second hearing device is configured to provide a mixer output that is based on only the second microphone signal from the second microphone of the second hearing device, when the first hearing device is in the second operation mode, and when the second hearing device is in an unmute mode.

27. The hearing system of claim 24, wherein the mixer of the second hearing device is configured to provide a mixer output that is based on only the first microphone signal from the first microphone of the first hearing device or only the audio signal, when the first hearing device is in the first operation mode, and when the second hearing device is in a mute mode.

28. The hearing system of claim 24, wherein the mixer of the second hearing device is configured to provide no output, a null output, a media output, or an output that is independent of the first microphone signal and the second microphone signal, when the first hearing device is in the second operation mode, and when the second hearing device is in a mute mode.

29. The hearing system of claim 1, wherein when the first hearing device is in the second operation mode, the first communication unit and/or the first antenna is disabled by reducing or removing power supplied to the first communication unit and/or to the first antenna.

30. The hearing system of claim 1, wherein when the first hearing device is in the second operation mode, the first communication unit and/or the first antenna is disabled by an operation of a switch inside the hearing device.

31. The hearing system of claim 1, wherein when the first hearing device is in the second operation mode, the second communication unit of the second hearing device is in a standby mode.

32. The hearing system of claim 1, wherein the first operation mode of the first hearing device is an unmute mode, and the second operation mode of the first hearing device is a mute mode.

33. The hearing system of claim 1, wherein the first antenna of the first hearing device comprises a magnetic induction antenna.

34. The hearing system of claim 33, wherein the magnetic induction antenna is configured to transmit the first microphone signal or the audio signal as audio data.

35. The hearing system of claim 33, wherein the first hearing device further comprises an additional first antenna configured to communicate with an exterior device.

36. The hearing system of claim 35, wherein the exterior device comprises a remote control, a phone, or a watch, a tablet, a computer, or a communication device.

37. The hearing system of claim 35, wherein the additional first antenna of the first hearing device is configured to provide communication at 2.4 GHz.

38. The hearing system of claim 35, wherein the additional first antenna of the first hearing device is configured to communicate non-audio data with the second hearing device.

39. The hearing system of claim 38, wherein the non-audio data comprises control data.

40. The hearing system of claim 38, wherein the second hearing device comprises an additional second antenna configured to communicate with the additional first antenna of the first hearing device.

41-86. (canceled)
